(19) United States
(12) Patent Application Publication
(10) Pub. No.: US 2013/0194579 A1
(43) Pub. Date: Aug. 1, 2013

(54) INSPECTION APPARATUS

(71) Applicants: Yukihisa Mohara, Hitachinaka (JP); Hidetoshi Nishiyama, Hitachinaka (JP); Shuichi Chikamatsu, Kounosu (JP); Eiji Imai, Hitachinaka (JP); Koichi Taniguchi, Toride (JP)

(72) Inventors: Yukihisa Mohara, Hitachinaka (JP); Hidetoshi Nishiyama, Hitachinaka (JP); Shuichi Chikamatsu, Kounosu (JP); Eiji Imai, Hitachinaka (JP); Koichi Taniguchi, Toride (JP)

(21) Appl. No.: 13/818,781

(22) PCT Filed: Jul. 19, 2011
(86) PCT No.: PCT/JP2011/004066

§ 371 Date: Mar. 12, 2013

(30) Foreign Application Priority Data
Sep. 27, 2010 (JP) 2010-214662

(51) Int. Cl. G01N 21/95

(52) U.S. Cl. CPC G01N 21/9501
USPC 356/450; 356/237.5

(57) ABSTRACT

In a conventional art, vibrations of compositions (for example, a Z-stage, a θ-stage, a wafer chuck, and a detection optical system mounted above a stage linear scale) within a device are not precisely fed back to a coordinate value.

The present invention provides an inspection apparatus that inspects a substrate, including: a substrate holder that holds the substrate; a travel unit that travels the substrate holder; an irradiation unit that irradiates the substrate with light; a charge storage detector that detects the light from the substrate, and stores electric charges; a measurement unit that measures a change in relative position between the substrate holder and the travel unit; and a processing unit, in which the charge storage detector stores the electric charges on the basis of a charge transfer signal obtained on the basis of a measurement result from the measurement unit, and the processing unit detects a defect of the substrate with the use of an image generated by storing the electric charge on the basis of the charge transfer signal.

### TECHNICAL FIELD

The present invention relates to an inspection apparatus and an inspection method for inspecting a substrate.

For example, the present invention relates to a semiconductor inspection apparatus and an inspection method which are used in a semiconductor manufacturing process.

### BACKGROUND ART

A manufacture of a semiconductor device is classified into a front end process and a back end process. The front end process includes isolation formation, well formation, gate formation, source/drain formation, interlayer insulating film formation, and flattening. The back end process repeats contact plug formation, interlayer insulating film formation, flattening, metal wiring formation, and finally conducts passivation film formation. During the above manufacturing process, a wafer is removed to conduct a defect inspection. In this case, defect represents foreign matter or scratch of a wafer surface, and a pattern defect (short, open, via non-opening, etc.), and so on.

Purposes of the defect inspection are to first manage a state of a manufacturing device, and to second specify a defect occurrence process and its cause. For that reason, a high detection sensitivity is required for a defect inspection apparatus associated with miniaturization of a semiconductor device. In the defect inspection apparatus, a method is frequently used in which images between adjacent or close chips are compared with each other. This is a method utilizing a fact that several hundreds of semiconductor devices (called “chips” or “dies”) having a pattern of the same structure are fabricated on a single wafer. This method is particularly widely used for in-line inspection in the defect inspection apparatus that compares a dark field image.

Patent Literature 1 discloses an inspection stage and a position correction control technique for conducting comparative inspection of the wafer at high speed with high sensitivity.

Patent Literature 2 discloses a method of detecting a change in a relative position between stages, and conducting pixel position correction on image information acquired on the basis of the relative position information, and capture of a display image.

Patent Literature 3 discloses a method of positionally correcting a captured image obtained by photographing an object to be inspected, and adjusting and correcting a direction of an image sensor that photographs the object to be inspected.

### CITATION LIST

### Patent Literature

Patent Literature 1: JP-A Sho-62 (1987)-89336
Patent Literature 2: JP-A-2006-252800
Patent Literature 3: JP-A-2009-10325

### SUMMARY OF INVENTION

### Technical Problem

In the defect inspection apparatus, in order to detect a miniaturized defect at high speed, there is a need to lessen a position deviation of an inspection stage projected on an inspection image as much as possible, and the inspection stage at higher speed with higher precision is required. In the conventional art, image position correction and capture position correction are conducted, and those position corrections are conducted with image information acquired for each scanning of the image sensor as one correction unit. However, in the present invention, it is found that the above conventional art suffers from, for example, the following problems.

(1) The position deviation of the image sensor by one scanning or smaller cannot be reflected on the captured image in each scanning.

(2) Because a travel distance of the inspection stage is measured by a stage linear scale which is distant in a height direction, when coordinate values calculated from the stage linear scale are used, vibrations of compositions (for example, a Z-stage, a θ-stage, a wafer chuck, and a detection optical system mounted above the stage linear scale) within the device are not precisely fed back to the inspection image.

### Solution to Problem

The present invention has the following features.

The present invention may provide the following features, independently or in combination.

(1) According to the present invention, there is provided an inspection apparatus that inspects a substrate, including: a substrate holder that holds the substrate; a travel unit that travels the substrate holder; an irradiation unit that irradiates the substrate with light; a charge storage detector that detects the light from the substrate, and stores electric charges; a measurement unit that measures a change in relative position between the substrate holder and the travel unit; and a processing unit, wherein the charge storage detector stores the electric charges on the basis of a charge transfer signal obtained on the basis of a measurement result from the measurement unit, and wherein the processing unit detects a defect of the substrate with the use of an image generated by storing the electric charge on the basis of the charge transfer signal.

(2) According to the present invention, the measurement unit includes a first measurement unit that measures a change in position of the substrate holder.

(3) According to the present invention, the first measurement unit includes a first interference optical system, and a reference light and an inspection light of the first interference optical system are parallel to a travel direction of the travel unit.

(4) According to the present invention, the first interference optical system is arranged through the travel unit and a frame.

(5) According to the present invention, the first interference optical system is located at a distance from the travel unit.

(6) According to the present invention, the inspection apparatus includes an imaging unit that images the light from the substrate on the charge storage detector, and the measurement unit includes a second measurement unit that measures a change in position of the imaging unit.

(7) According to the present invention, the second measurement unit includes a second interference optical system, and a reference light and an inspection light of the second interference optical system are parallel to a travel direction of the travel unit.

(8) According to the present invention, the second interference optical system is arranged through the travel unit and a frame.

(9) According to the present invention, the second interference optical system is located at a distance from the travel unit.

(10) According to the present invention, the processing unit changes a brightness of an image in response to a change in the charge transfer signal.

(11) According to the present invention, the inspection apparatus includes: a pulse source that outputs a pulse for determining a charge transfer signal before correction; and a high frequency pulse source having a higher frequency than that of the pulse source, in which the processing unit corrects the charge transfer signal before correction on the basis of a pulse from the high frequency pulse source, and the charge transfer signal after correction is output from the high frequency pulse source.

(12) According to the present invention, there is provided an inspection apparatus that inspects a substrate, including: a substrate holder that holds the substrate; a travel unit that travels the substrate holder; an irradiation unit that irradiates the substrate with light; a charge storage detector that detects the light from the substrate, and stores electric charges; and a processing unit, in which the processing unit obtains a position deviation of the substrate from at least two images, and determines a charge transfer signal for allowing the charge storage detector to store the electric charges from the position deviation, the charge storage detector stores the electric charge on the basis of the charge transfer signal obtained from the position deviation, and the processing unit detects a defect of the substrate with the use of an image generated by storing the electric charge on the basis of the charge transfer signal.

(13) According to the present invention, the processing unit changes brightness of the image in response to a change in the charge transfer signal.

### Advantageous Effects of Invention

The present invention obtains, for example, the following advantageous effects.

The present invention may obtain the following advantageous effects, independently or in combination.

(1) The position deviation of the image sensor by one scanning or smaller can be reflected on the captured image in each scanning.
(2) Even if a travel distance of the inspection stage is measured by the stage linear scale which is distant in the height direction, vibrations of compositions (for example, a Z-stage, a θ-stage, a wafer chuck, and a detection optical system mounted above the stage linear scale) within the device can be precisely fed back to the inspection image.
(3) High-speed inspection can be realized.
(4) A position of the defect can be precisely detected.
(5) A high-precision transport system can be configured with an inexpensive configuration.
(6) A device performance can be maintained even under poor environments.
(7) Precise inspection can be conducted even if an abnormality occurs in the transport system.

The above and other features of the present invention will be further described below.

### BRIEF DESCRIPTION OF DRAWINGS

FIG. 1 is a diagram illustrating a device configuration of a first embodiment.

FIG. 2 is a diagram illustrating a case in which a measurement unit 110 is not used.

FIG. 3 is a diagram illustrating details of the first embodiment.

FIG. 4 is a flowchart of the first embodiment.

FIG. 5 is a diagram illustrating a device configuration of a second embodiment.

FIG. 6 is a diagram illustrating a device configuration of a third embodiment.

FIG. 7 is a diagram illustrating details of the third embodiment.

FIG. 8 is a diagram illustrating a fourth embodiment.

FIG. 9 is a diagram illustrating a device configuration of a fifth embodiment.

FIG. 10 is a diagram illustrating image processing which is conducted in an image processing unit 114 in the fifth embodiment.

FIG. 11 is a flowchart illustrating details of the fifth embodiment.

FIG. 12 is a diagram illustrating a sixth embodiment.

FIG. 13 is a diagram illustrating a device configuration of a seventh embodiment.

FIG. 14 is a diagram illustrating a seventh embodiment.

FIG. 15 is a flowchart illustrating an eighth embodiment.

FIG. 16 is a diagram illustrating plot results displayed in the eighth embodiment.

FIG. 17 is a diagram illustrating a ninth embodiment.

### DESCRIPTION OF EMBODIMENTS

The present invention can be designed, for example, to output a signal (charge transfer signal to be described later) for determining a storage time of a charge storage detector on the basis of a measurement result of a measurement unit (measurement unit 110 to be described later) that measures a change in relative position between a substrate and a stage.

In another design, the present invention can be designed, for example, to obtain real position information of the substrate, and outputting a signal (charge transfer signal to be described later) for determining the storage time of the charge storage detector on the basis of the real position information.

Hereinafter, embodiments of the present invention will be described with reference to the drawings. A plurality of embodiments disclosed below can be combined with each other.

### First Embodiment

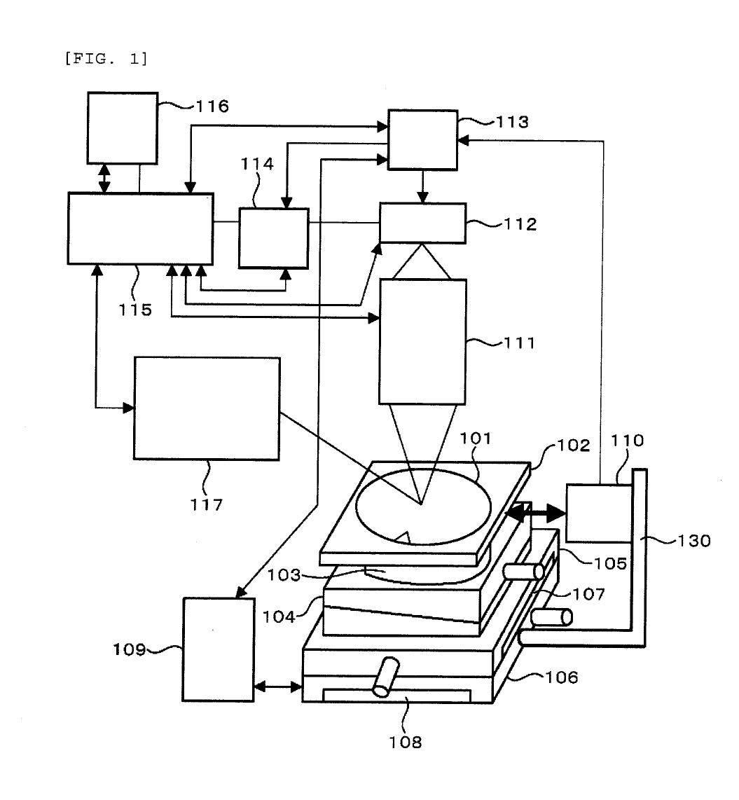

FIG. 1 is a diagram illustrating a device configuration of a first embodiment.

Main constituent elements of a defect inspection apparatus according to the first embodiment are a transport system (wafer chuck 102 that holds and mounts a wafer 101, a θ stage 103 that rotates the wafer by θ, a Z-stage 104 that travels the wafer vertically, a Y stage 105 that travels the wafer in a Y direction, an X stage 106 that travels the wafer in an X direction, a Y stage linear scale 107 that measures a travel distance of the Y stage, an X stage linear scale 108 that measures a travel distance of the X stage, etc.), a stage controller 109 that controls the respective stages, a measurement unit 110 that measures a travel distance of the wafer chuck, a frame 130 that supports the measurement unit 110, a detection optical system 111 (for example, imaging system) formed of a lens and the like, a detector 112, a sensor control unit 113, an image processing unit 114, an overall control unit 115, an input/output operation unit 116, and an illumination optical system 117.

When the wafer 101 is loaded into the defect inspection apparatus, an operator inputs information such as a manufacturing process or a target defect to the input/output operation unit 116.

The overall control unit 115 selects an optimum wavelength bandwidth with reference to a database stored by using the above information through simulation or experiment in advance as will be described later, and also controls the respective units.

The illumination optical system 117 illuminates the wafer 101 obliquely with light. Since a regular reflected light from the wafer 101 is output to an exterior of an opening of the detection optical system 111, a dark field image is obtained by the detection optical system 111 of this first embodiment. The light that has penetrated through the detection optical system 111 is imaged on the detector 112. The detector 112 includes an image sensor and an A/D converter.

The detector 112 is an image sensor having a plurality of pixels, for example, a time delay integration (TDI) sensor. The detector 112 is, for example, a charge storage detector that stores electric charges for a given time, and a charge storage time is determined according to a charge transfer signal S which will be described later. An integration direction of the electric charges, a scanning direction of the X stage 106, and a short side direction of a viewing field in the detector 112 are identical with each other.

A travel distance of the stage, which has been measured by the X stage linear scale 108, is transferred from the stage controller 109 to the sensor control unit 113, and a synchronization signal (charge transfer signal S) for transferring electric charges of the detector 112 is generated by a pulse source within the sensor control unit 113. The signal is supplied to the detector 112 to acquire an inspection image. In this situation, a travel distance of the wafer chuck 102, which has been measured by the measurement unit 110, is transferred to the sensor control unit 113. Then, the sensor control unit 113 corrects the travel distance of the stage according to the travel distance of the wafer chuck 102, and generates a corrected charge transfer signal S1 according to the corrected travel distance.

With the above configuration, a real travel distance of the wafer chuck 102 mounted on the X stage 106 can be obtained, and an inspection image resulting from feeding back the vibrations of the θ stage 103, the Z-stage 104, and the Y stage 105 can be obtained.

Thus, in the system of this embodiment, the sensor control unit 113 can be designed to determine the charge transfer signal of the detector 112 on the basis of a measurement result of the measurement unit 110. In another design, the sensor control unit 113 can be designed, for example, to determine the charge transfer signal of the detector 112 on the basis of a travel distance of the wafer chuck, in other words, the wafer.

Subsequently, the measurement unit 110 will be described in detail.

The measurement unit 110 is an interference optical system using a phase difference between the reference light and the inspection light, for example, a laser interferometer. It is needless to say that the measurement unit 110 may not be the laser interferometer if the measurement unit can measure the travel distance of the wafer.

In the first embodiment, the measurement unit 110 is fixed to the L-shaped frame 130, and the frame 130 is fixed to the X stage 106.

The wafer chuck 102 is configured to be illuminated with the light of the measurement unit 110. More specifically, in the first embodiment, the measurement unit 110 is arranged through the frame 130 in a direction corresponding to a travel direction of the X stage. As another design, the travel direction of the X stage, the reference light of the measurement unit 1100, and the inspection light can be designed to be parallel to each other.

This case can obtain the following advantages.

(1) The measurement unit 110 can measure the amount of displacement of the wafer position.

(2) The measurement unit 110 can be put close to the wafer, and the measurement unit 110 can be inexpensively configured.

Thus, the inspection image resulting from feeding back the vibrations of the device is converted into a digital signal, and transferred to the respective processing circuits of the image processing unit 114.

A reference image acquired by chips having the same circuit pattern which are adjacent or close to the inspection chip is recorded in the image processing unit 114. The image processing unit 114 conducts processing such as positioning on the inspection image and the reference image, and thereafter outputs a difference image between both of those images. The image processing unit 114 compares a brightness of the difference image with a predetermined threshold value to determine whether a defect is present, or not.

The determination result of the defect is transmitted to the overall control unit 115, and displayed in the input/output operation unit 116 after a given inspection has been completed.

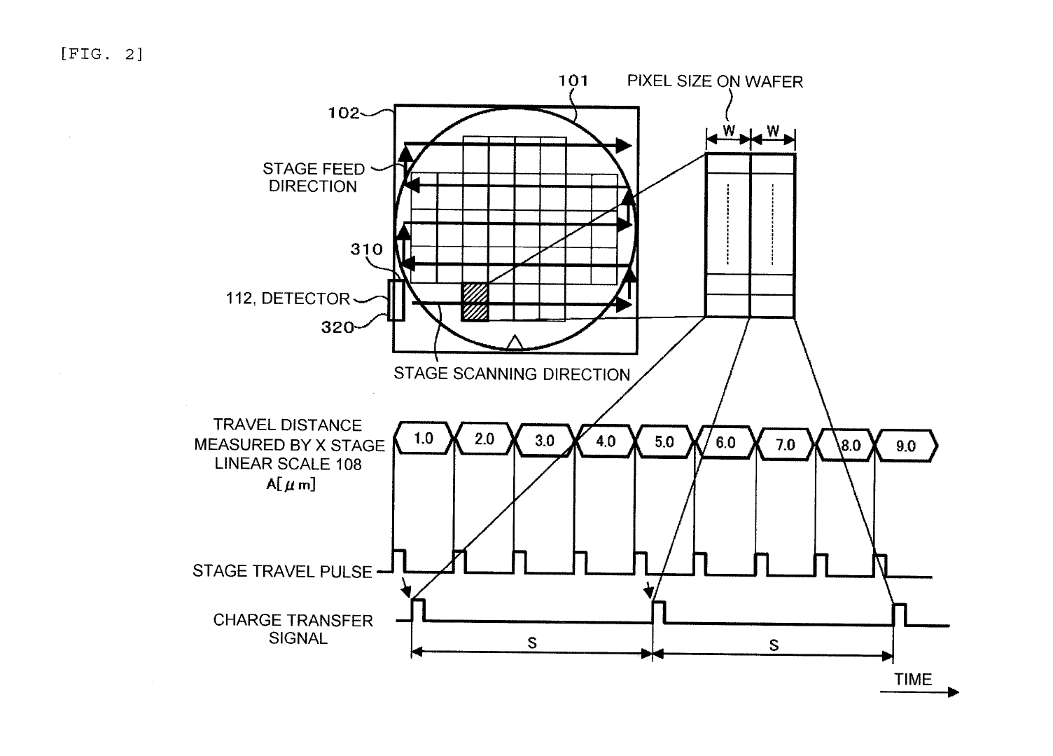

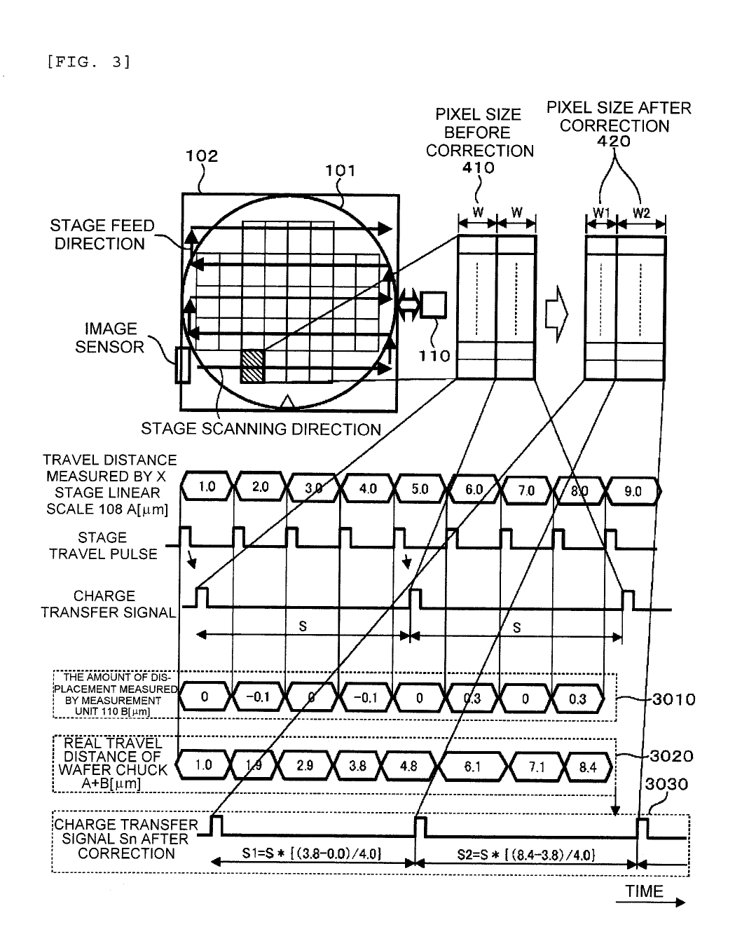

Subsequently, the first embodiment will be described in more detail with reference to FIGS. 2 and 3.

In the description of the first embodiment, a case using no measurement unit 110 will be first described.

FIG. 2 is a diagram illustrating a case using no measurement unit 110. A lateral direction 301 of the detector 112 is a scanning direction (X direction) of the X stage, and a longitudinal direction 320 thereof is a feed direction (Y direction) of the Y stage. In the defect inspection apparatus according to the first embodiment, scanning operation is repeated in such a manner that the detector 112 first travels in the X direction, then turns in the Y direction and travels.

The detector 112 stores electric charges during one cycle S of the charge transfer signal (in the first embodiment, four stage travel pulses), and conducts transfer processing. Hence, if the detector 112 outputs the charge transfer signal S every time the stage travels on the wafer by a pixel size W, the captured image of the pixel size W is obtained.

In FIG. 2, one stage travel pulse is output every time the X stage linear scale 108 travels by 1 [μm]. Then, in response to that pulse, a pulse serving as a start point of the charge transfer signal is also output, and once four stage travel pulses are output, a pulse serving as an end point of the charge transfer signal is output. The four stage travel pulses form the charge transfer signal S, and the pixel size W really acquired corresponds to the charge transfer signal S.

However, in this system, when the wafer chuck 102, the θ stage 103, the Z-stage 104, and the Y stage 105 mounted on the X stage vibrate, the travel distance of the wafer chuck 102, that is, the wafer 101 due to the vibrations is not measured by the linear scale. For that reason, a difference occurs between a real travel distance of the wafer 101 and the travel distance of the linear scale.

This difference causes the reduced sensitivity or the deviation of coordinates when reviewing the detected defect.

Subsequently, a case using the measurement unit 110 will be described with reference to FIG. 3. The processing until the charge transfer signal S is output is identical with that in FIG. 2.

In the first embodiment, the measurement unit 110 measures the amount of displacement B of the wafer chuck 102 in synchronization with the stage travel pulses (3010 in FIG. 3). Then, the measurement unit 110 calculates a real travel distance A+B of the wafer chuck 102 (3020 in FIG. 3). Then, the measurement unit 110 calculates a corrected charge signal Sn on the basis of the real travel distance A+B of the wafer chuck 102.

For example, as indicated by reference numeral 3030 in FIG. 3, when a travel distance A of the X stage, which has been measured by the X stage linear scale 108, is 4 [μm], and a real travel distance B of the wafer chuck, which has been measured by the measurement unit 110 (a time within the number of stage travel pulses for generating the charge transfer signal S) in response to A, is 3.8 [μm], the corrected charge transfer signal Sn is represented as follows.

Sn=S1=S*{(3.8−0.0)/4.0}

Also, if A is 8 [μm] and A+B is 8.4 [μm], a corrected charge transfer signal S2 after S1 is represented as follows.

Sn=S2=S*{(8.4−3.8)/4.0}

A corrected pixel size 420 is W1 and W2 in correspondence with S1 and S2, respectively.

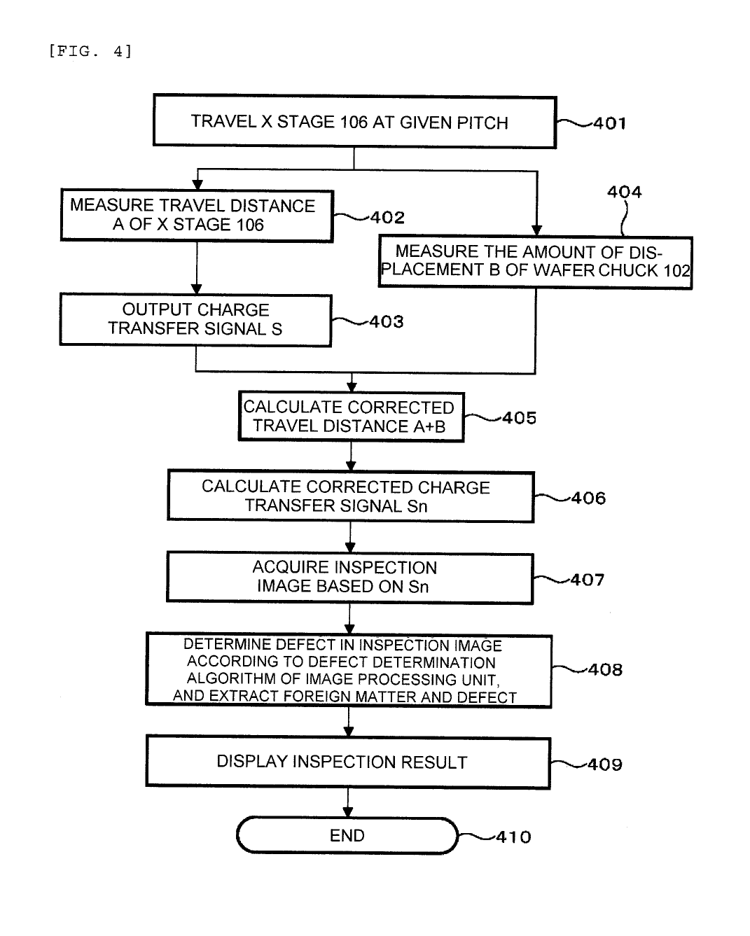

In short, the first embodiment can be expressed by a flowchart of FIG. 4.

In Step 401, the X stage 106 travels at a given pitch.

In Step 402, the travel distance A of the X stage is measured.

In Step 403, the charge transfer signal S is output on the basis of A.

In Step 404, the amount of displacement B of the wafer chuck 102, that is, the wafer 101 is measured in parallel to S2 and S3.

In Step 405, the corrected travel distance A+B is calculated.

In Step 406, the corrected charge signal Sn is calculated on the basis of the corrected travel distance A+B.

In Step 407, the inspection image is acquired on the basis of Sn.

In Step 408, the inspection image is determined as a defect by a defect determination algorithm, and a foreign matter or the defect is extracted.

In Step 409, the inspection result is displayed.

In Step 410, the inspection is completed.

This embodiment can obtain the following advantages.

(1) The position deviation of the image sensor by one scanning or smaller can be reflected on the captured image in each scanning.
(2) Even if the travel distance of the inspection stage is measured by the stage linear scale which is distant in the height direction, the vibrations of compositions (for example, the Z-stage, the θ-stage, the wafer chuck, and the detection optical system mounted above the stage linear scale) within the device can be precisely fed back to the inspection image.
(3) The high-speed inspection can be realized.
(4) The position of the defect can be precisely detected.
(5) The high-precision transport system can be configured with the inexpensive configuration.
(6) The device performance can be maintained even under poor environments.
(7) The precise inspection can be conducted even if an abnormality occurs in the transport system.

### Second Embodiment

Subsequently, a second embodiment will be described.

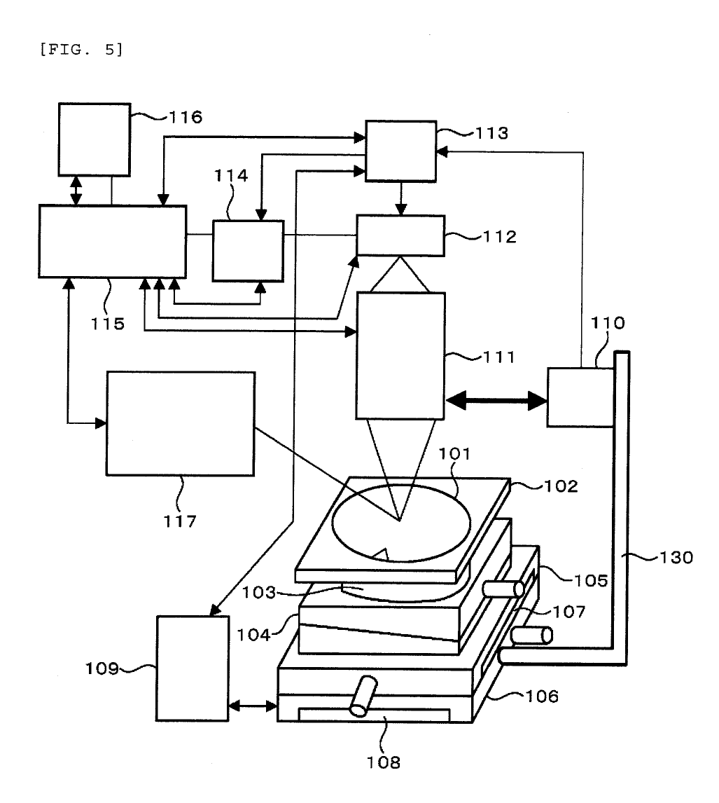

FIG. 5 illustrates a device configuration of the second embodiment. A difference of the second embodiment from the first embodiment resides in that the measurement unit 110 measures a change in the position of the detection optical system 111 due to the vibrations. A method of generating the corrected charge transfer signal is identical with that in the first embodiment.

In the second embodiment, the change in the position of the detection optical system can be reflected on the inspection image.

### Third Embodiment

Subsequently, a third embodiment will be described.

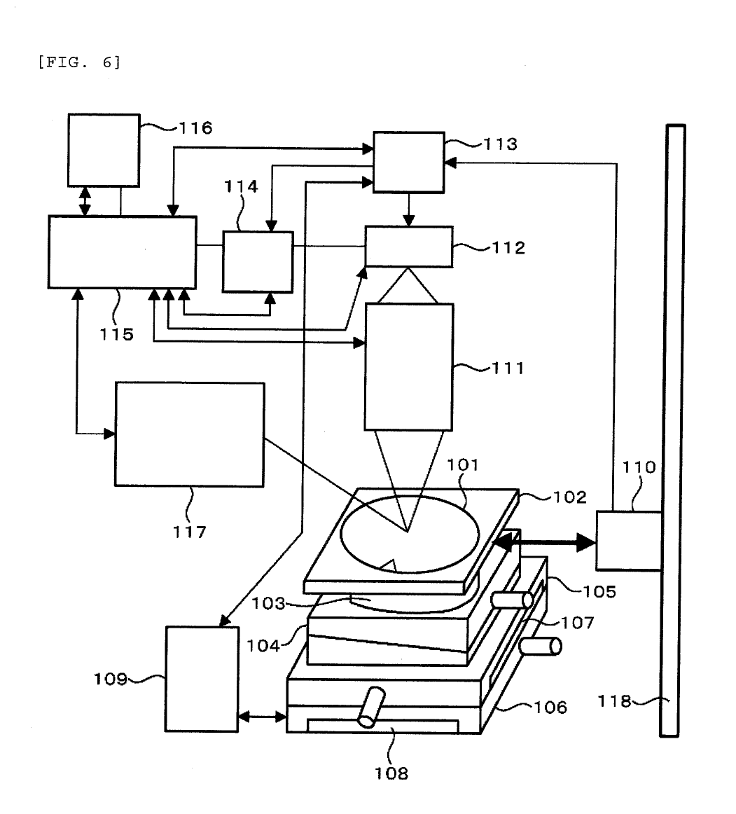

FIG. 6 illustrates a device configuration of the third embodiment.

A difference from the above-mentioned first and second embodiments resides in that the measurement unit 110 is not disposed on the frame 130 fixed to the X stage 106 as in the first and second embodiments, but is located at a distance (for example, a part of a device housing, hereinafter referred to as “device mount 118”) from the transport system such as the X stage 106.

With the above configuration, in the third embodiment, the real travel distance A+B of the wafer chuck can be directly measured. Also, the configuration of the transport system can be more simplified.

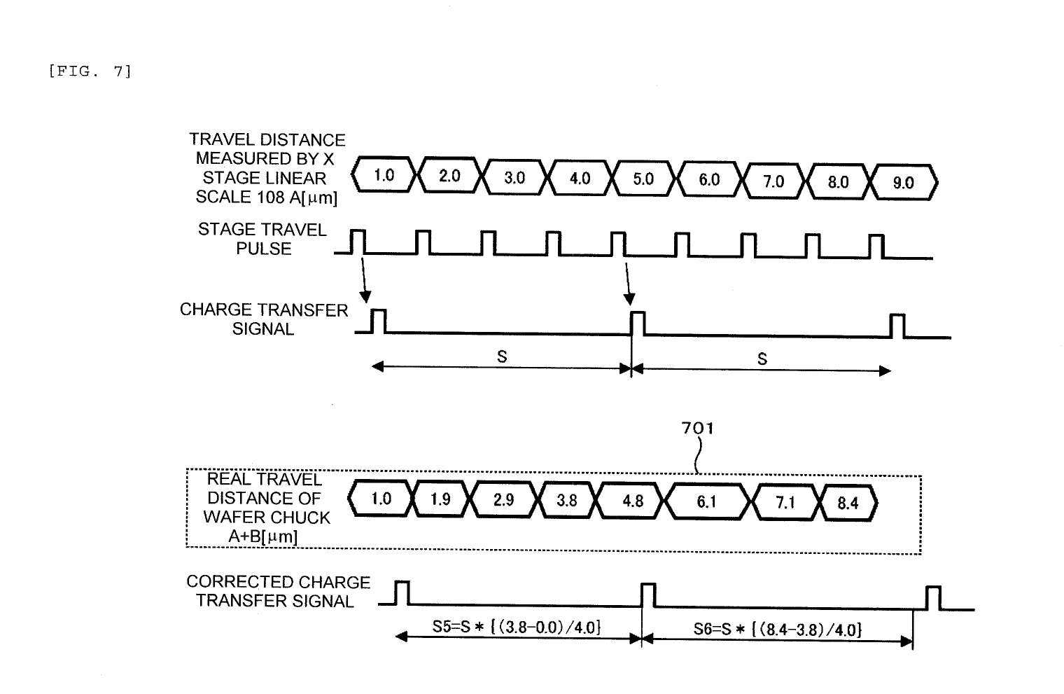

FIG. 7 is a diagram illustrating details of the third embodiment. The processing until the charge transfer signal S is generated is identical with that in the first embodiment.

In the third embodiment, the measurement of only the amount of displacement B as in the first embodiment is not conducted. The result of the measurement by the measurement unit 110 becomes the travel distance of the wafer chuck 102 as it is (701 in FIG. 7).

### Fourth Embodiment

Subsequently, a fourth embodiment will be described.

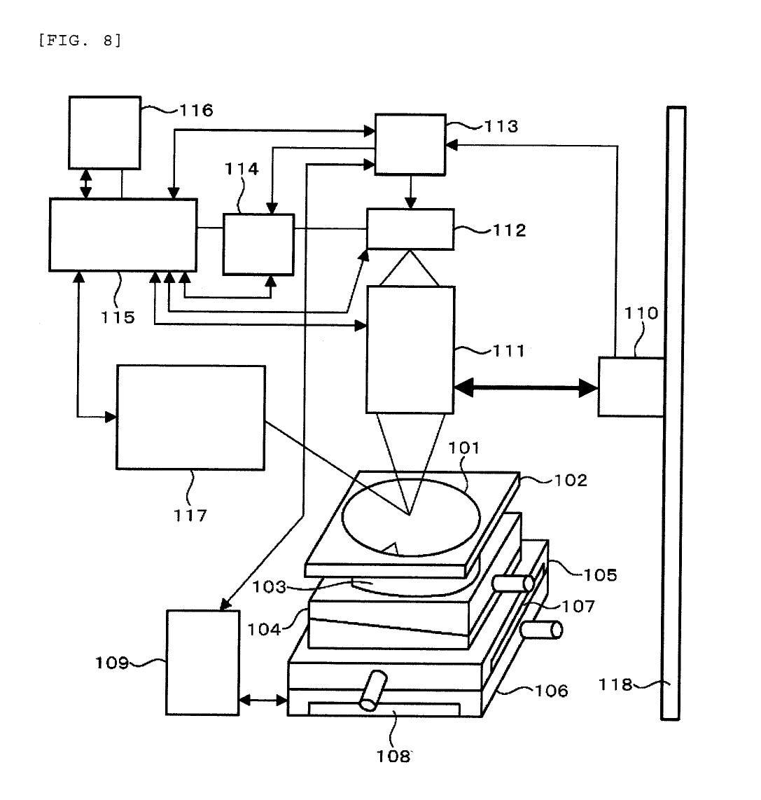

FIG. 8 illustrates a device configuration according to the fourth embodiment. A difference from the above-mentioned third embodiment resides in that not the wafer chuck 102 is measured, but the measurement unit 110 is located on the device mount 118 to measure a change in the position of the detection optical system 111.

With the above configuration, in the fourth embodiment, a change in the position of the detection optical system due to the vibrations can be directly measured. Also, the configuration of the transport system can be more simplified.

### Fifth Embodiment

Subsequently, a fifth embodiment will be described.

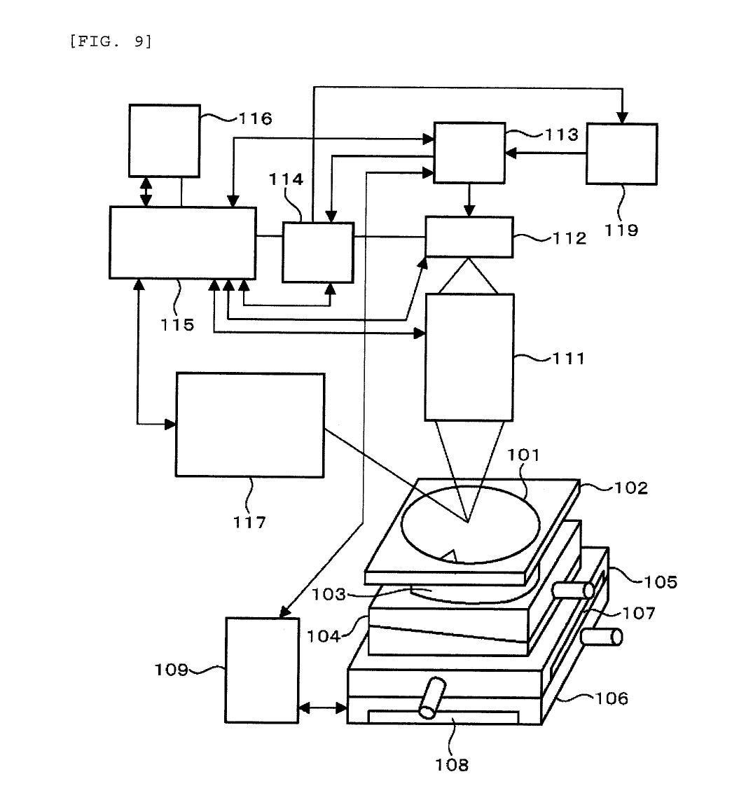

FIG. 9 illustrates a device configuration of the fifth embodiment. A difference from the above-mentioned first to fourth embodiments resides in that there is provided a processing unit that acquires at least two images and calculates the position deviation of the substrate on the basis of he two images, and the charge transfer signal is changed on the basis of the position deviation.

More specifically, the corrected charge transfer signal is generated in the sensor control unit 113 on the basis of the processing result of the image processing unit 114 with the additional provision of a position deviation information storage unit 119 without using the measurement unit 110.

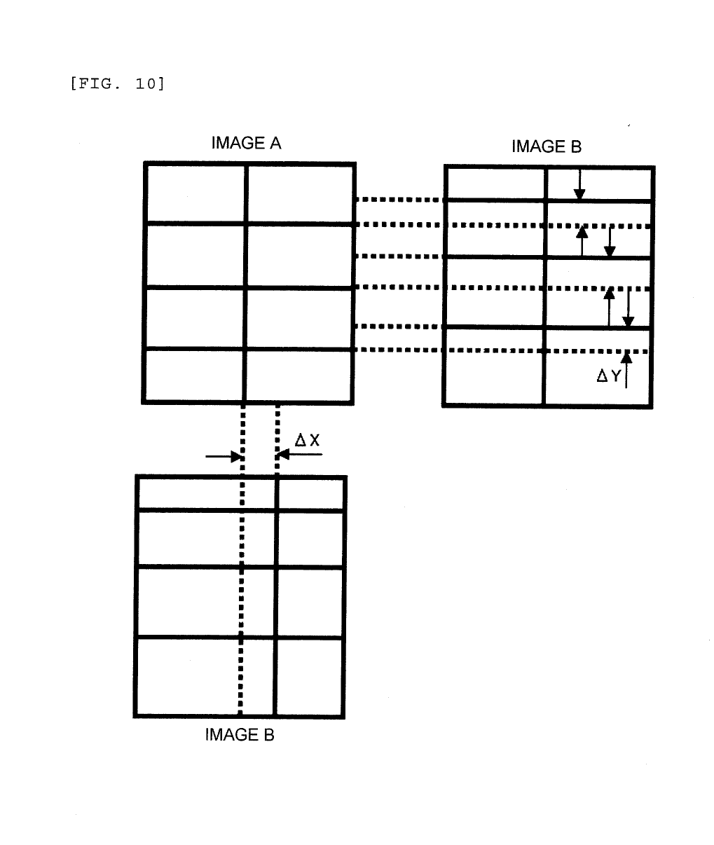

FIG. 10 is a diagram illustrating image processing which is conducted by the image processing unit 114 in the fifth embodiment.

In the fifth embodiment, at least two images A and B before and after the X stage travels are acquired prior to inspection. In this example, it is desirable that the images A and B are images having the same pattern formed (for example, the same circuit pattern or the same alignment mark).

The image processing unit 114 calculates the respective position deviations ΔX and ΔY of the images A and B in the X direction and the Y direction. If the images A and B have the same pattern formed, ΔX and ΔY can be calculated according to the deviation of this pattern. ΔX and ΔY may be visually recognized from the difference image of the images A and B by an operator.

The position deviations ΔX and ΔY are stored in the position deviation information storage unit 119. The sensor control unit 113 generates a corrected charge transfer signal S9 on the basis of the position deviations ΔX and ΔY.

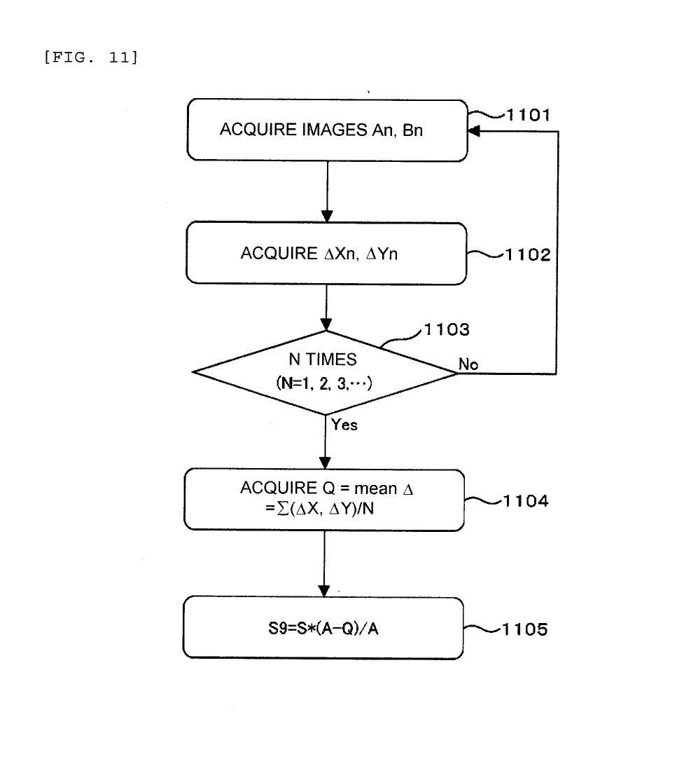

FIG. 11 is a flowchart illustrating details of the fifth embodiment.

In Step 1101, images An and Bn are acquired.

In Step 1102, position deviations ΔXn and ΔYn are calculated on the basis of the images An and Bn.

In Step 1103, it is determined whether processing of Steps 1101 and 1102 is repeated by N times, or not.

In Step 1104, a constant Q is calculated on the basis of the position deviations ΔXn and ΔYn. The constant Q is a value representing how much the position deviation occurs in the wafer chuck by the operation of the transport system, and can be represented as follows.

Q=mean Δ=L(ΔX,ΔY)/N

In Step 1109, the corrected charge transfer signal S9 is generated on the basis of the calculated Q and inspected. In this example, S9 can be represented as follows.

S9=S*(A−Q)/A

(S: charge transfer signal before correction, A: travel distance measured by X stage scale.

The fifth embodiment is effective particularly when the position deviation is constant, and the same advantages as those in the above-mentioned embodiments can be obtained with a simple device configuration without using the measurement unit 110.

### Sixth Embodiment

Subsequently, a sixth embodiment will be described.

The sixth embodiment is characterized in that the brightness of the image is changed in response to a change in the charge transfer signal.

When the charge transfer signal is made variable as in the above-mentioned first to fifth embodiments, it is conceivable that the amount of stored charge is changed in response to a variable amount even if the same image is taken. That is, the brightness of the image (brightness data) is changed.

In the first to fifth embodiments, even if the brightness data is changed, the sufficiently excellent advantages can be obtained as compared with the conventional art. However, for example, if the corrected charge transfer signal is extremely shorter (or longer) than the charge transfer signal before correction, the obtained image data may be extremely dark (or light). Hence, it is desirable that the brightness data is identical with that before the charge transfer signal is changed.

Under the circumstances, the sixth embodiment is to solve a problem that the brightness data is changed by making the charge transfer signal variable. That is, in the sixth embodiment, the image processing unit 114 of the first to fifth embodiments corrects the brightness data on the basis of a change in the charge transfer signal.

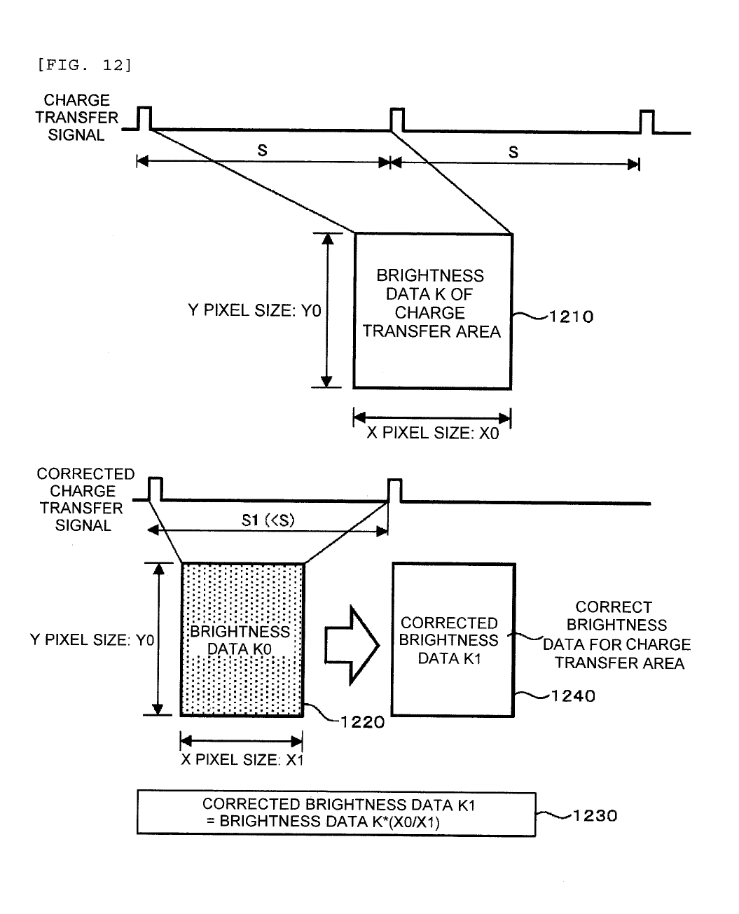

FIG. 12 is a diagram illustrating the sixth embodiment.

First, a relationship between pixels and brightness data will be described. First, a size of one pixel of an image obtained in this embodiment can be expressed by a product of an X pixel size X0 and a Y pixel size Y0 as indicated in 1210. In this example, the X pixel size X0 corresponds to the operation of the X stage, and therefore corresponds to the charge transfer signal S. The Y pixel size corresponds to a size of a spot light formed on the wafer 101. Then, the brightness within one pixel is bright data K.

Subsequently, a case in which the charge transfer signal is changed will be described. It is assumed that the charge transfer signal S has been corrected to the corrected charge transfer signal S1 by the above-mentioned first to fifth embodiments. In this example, it is assumed that S1 is smaller than S. In this example, since the X pixel size corresponds to the charge transfer signal, when S becomes S1, the X pixel size also changes from X0 to X1. The Y pixel size does not depend on the charge transfer signal, and therefore is not changed from Y0. If S is changed to S1, the brightness data K0 becomes smaller than K, and the image becomes darker than the image before the charge transfer signal is corrected so that the image is expressed by black dots in 1220. Under the circumstances, the bright data is corrected on the basis of a change in the charge transfer signal as expressed in 1230.

Specifically, because a change in the charge transfer signal corresponds to a change in the X pixel size, corrected brightness data K1 represented by 11240 can be expressed by the following expression.

K1=K*(X0/X1)

In the sixth embodiment, inspection is conducted by using the images configured by the pixels having the corrected brightness data K1.

The sixth embodiment can solve the problem that the brightness data is changed by making the charge transfer signal variable. The sixth embodiment is effective particularly when the charge transfer signal is extremely changed.

### Seventh Embodiment

In the first to sixth embodiments, the examples in which the charge transfer signal is made variable are described.

In this example, when the pulse source of the charge transfer signal is a relatively low frequency (width between the pulses is large), and a change in the charge transfer signal is relatively slight, even if the corrected charge transfer signal can be calculated, the signal may not be output.

This is because a resolution performance of the corrected charge transfer signal depends on the frequency of the pulse source that generates the charge transfer signal.

This embodiment is to solve the above matter. Specifically, this embodiment can be designed to include a pulse source that outputs a pulse for determining the charge transfer signal before correction, and a high frequency pulse source having a frequency higher than that of the pulse source, in which the first control unit corrects the charge transfer signal before correction on the basis of the pulse from the high frequency pulse source, and the corrected charge transfer signal is output from the high frequency pulse source.

It is desirable that the frequency of the third pulse source is sufficiently higher than the frequency of a second pulse source. Specifically, it is desirable that the frequency of the third pulse source is several tens [MHz].

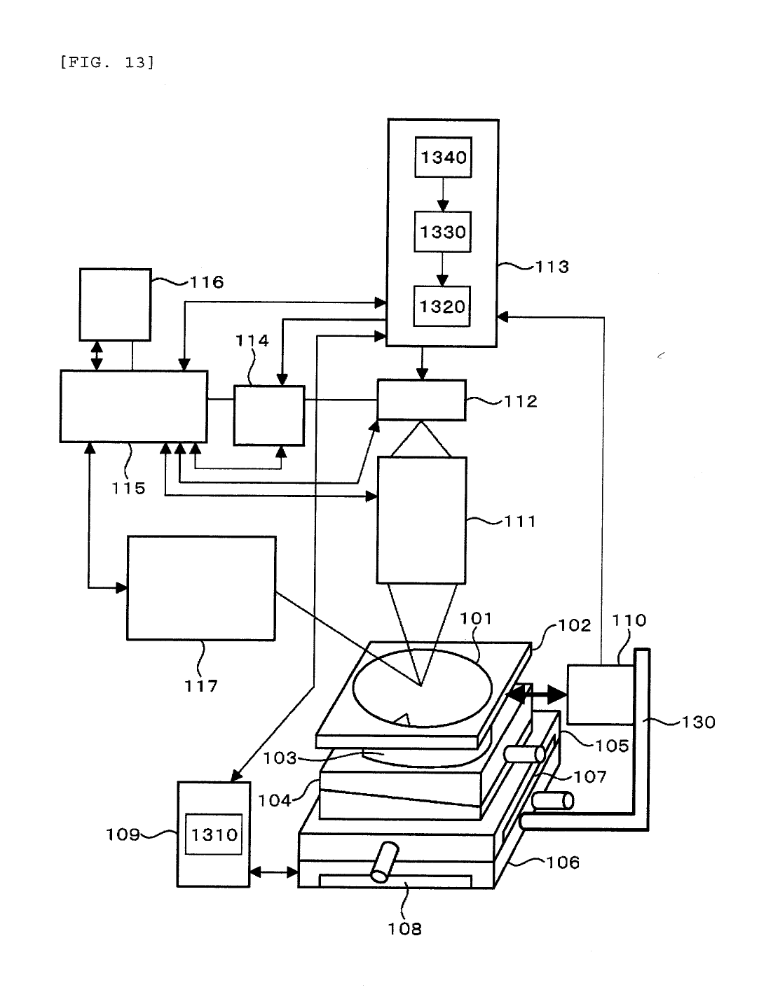

FIG. 13 is a diagram illustrating a device configuration of a seventh embodiment, which is a device configuration in which the seventh embodiment is applied to the first embodiment. The seventh embodiment can be also applied to the second to sixth embodiments. In the seventh embodiment, the stage controller 109 includes a first pulse source 1310 that outputs a stage travel pulse.

The sensor control unit 113 includes a second pulse source 1340 that outputs a second pulse for determining the charge transfer signal before correction, a third pulse source 1320 having a frequency higher than the second pulse source 1340, and a synchronizer circuit 1330 that synchronizes the second pulse source 1340 with the third pulse source 1320.

The other portions are identical with those in the first embodiment.

In the seventh embodiment, the corrected charge transfer signal is output on the basis of the pulse of the third pulse source.

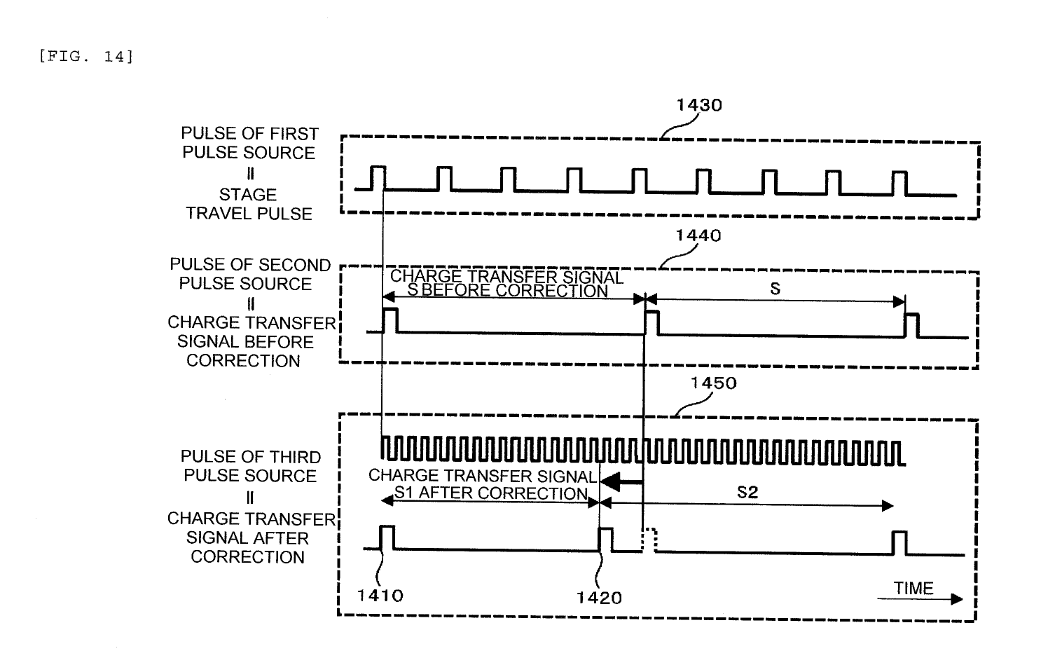

FIG. 14 is a diagram illustrating details of a seventh embodiment.

The stage travel pulse is output by the first pulse source 1310 (1430 in FIG. 14).

In the seventh embodiment, a pulse for determining the charge transfer signal S before correction is generated from the second pulse source 1340 in correspondence with the four stage travel pulses (for example, in synchronization with a falling thereof) (1440 in FIG. 14).

The pulse from the third pulse source 1320 is synchronized with a rising of the second pulse by the synchronizer circuit 1330.

Then, the corrected charge transfer signals S1 and S2 are calculated through the method illustrated in FIG. 3 (or methods of the other embodiments), a pulse 1410 representing a start point of the corrected charge transfer signal S1 is output from the third pulse source, and a pulse 1420 representing an endpoint of S1 is also output from the third pulse source (1450 in FIG. 14). In the seventh embodiment, the image is acquired on the basis of the corrected charge transfer signal to conduct the inspection.

In the seventh embodiment, the corrected charge transfer signal can be output with a pulse width of the sufficiently small third pulse as a unit. Hence, the seventh embodiment is effective particularly when a change in the charge transfer signal, that is, a change in the position of the wafer 101 is slight.

### Eighth Embodiment

Subsequently, an eighth embodiment will be described.

The first to seventh embodiments can observe the real travel distance of the wafer chuck.

Hence, a change of the transport system with time can be known by obtaining a relationship between the real travel distance of the wafer chuck and the number of inspections (a temporal change or a travel pitch of the stage may be present).

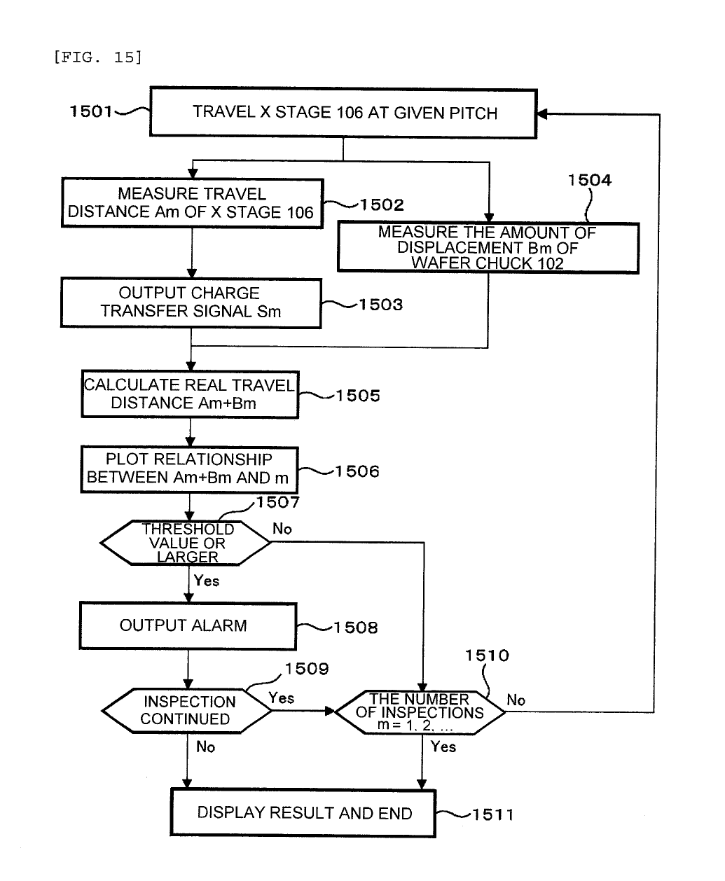

FIG. 15 is a flowchart conducted by the overall control unit 115 illustrating details of an eighth embodiment.

A concept of the eighth embodiment can be applied to the first to seventh embodiments. In FIG. 15, a case in which the concept of the eighth embodiment is applied to the first embodiment will be described.

The processing from Step 1501 to Step 1506 is substantially identical with that in FIG. 4.

In Step 1501, the X stage 106 travels at a given pitch.

In Step 1502, a travel distance Am of the X stage is measured.

In Step 1503, a charge transfer signal Sm is output on the basis of A.

In Step 1504, the amount of displacement Bm of the wafer chuck 102, that is, the wafer 101 is measured in parallel to 1502 and 1503.

In Step 1505, a corrected travel distance Am+Bm is calculated.

In Step 1506, a relationship between Am+Bm and m is stored and plotted.

In this situation, a relationship between Am and m, and a relationship between Bm and m may be stored in parallel, and plotted.

With the above configuration, an abnormality specific to the X stage 106, and an abnormality specific to the wafer chuck 102 can be known.

In Step 1507, it is determined whether Am+Bm is equal to or larger than a threshold value, or not. If Am+Bm is equal to or larger than the threshold value, the operation proceeds to Step 1508. If Am+Bm is smaller than the threshold value, the operation proceeds to Step S1520 which will be described later. A value of the threshold value can be arbitrarily set by a user.

In step 1508, since that Am+Bm exceeds the threshold value means that an abnormality occurs in the transport system, an alarm is output (the output may be arbitrarily set by the user).

In Step 1509, whether the inspection is continued, or not, is selected by the user (it is needless to say that whether to continue the inspection may be automatically selected by the overall control unit 115).

In the eighth embodiment, even if an abnormality occurs in the transport system, the correction can be conducted with reflection of the abnormality on the charge transfer signal. As a result, the inspection can be continued.

This advantage is remarkable particularly under the relatively poor device environments

In Step 1509, if “inspection is to be continued” is selected, the operation proceeds to Step 1510 which will be described later.

In Step 1509, if “inspection is not to be continued” is selected, the operation proceeds to Step 1511 which will be described later.

In Step 1510, it is confirmed whether the inspections reach a specified frequency m, or not.

If the inspections do not reach m, the operation returns to S1501.

If the inspections reach m, the operation proceeds to S1511 which will be described later.

In Step 1511, the plot result is displayed, the processing is completed.

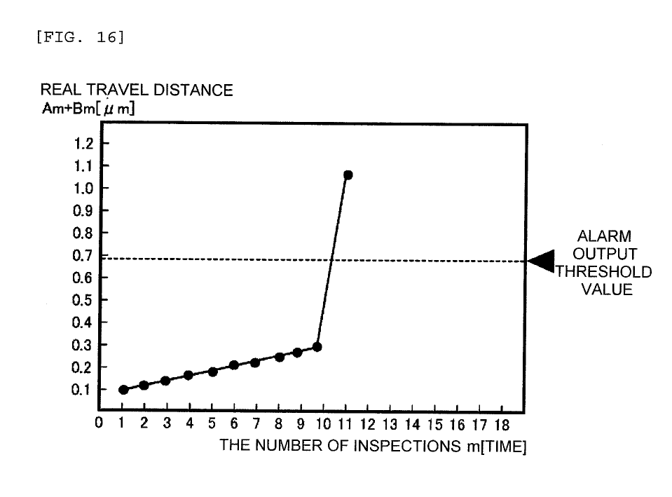

FIG. 16 illustrates a plot result displayed in the eighth embodiment.

Am+Bm is linear until the number of inspections is 10, and a change thereof is constant. This indicates that the transport system has no abnormality (or there is no problem in the inspection even if the abnormality occurs), and can travel at the given pitch.

On the other hand, when the number of inspections is 11, Am+Bm indicates an extremely high numerical value. This indicates that any abnormality that cannot be ignored in practical use occurs in the transport system.

In the eighth embodiment, an alarm is output once data is acquired in an eleventh inspection.

Thus, the inspection result is displayed so that the user can rapidly confirm that the abnormality occurs in the transport system.

As described above, in the eighth embodiment, after the abnormality has been confirmed, that is, after the eleventh inspection, since the correction can be conducted with reflection of the abnormality on the charge transfer signal. As a result, the inspection can be continued.

### Ninth Embodiment

Subsequently, a ninth embodiment will be described.

The ninth embodiment is to reduce an influence of a deviation of an imaging relationship between the detector and an image formed on the detector. The ninth embodiment can be applied to the first to eighth embodiments. In this example, a case in which a concept of the ninth embodiment is applied to the first embodiment will be described.

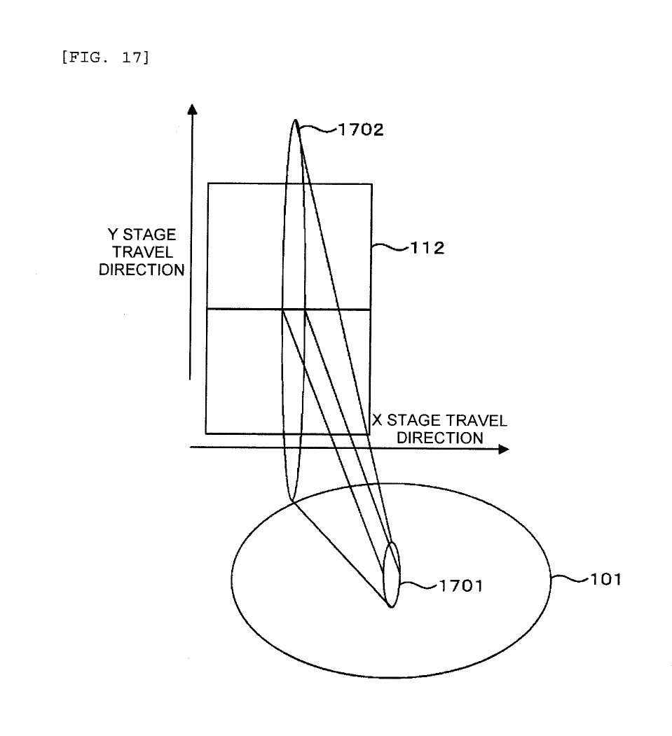

FIG. 17 is a diagram illustrating the ninth embodiment.

The wafer 101 is illuminated with the light from the illumination optical system 117 in FIG. 1 as an illumination spot shaped into a thinned ellipse (thinned illumination 1701). A scattered light from the wafer 101 in FIG. 1 is imaged on the detector 112 through the detection optical system 111 as an image 1702.

In this example, it is desirable that the image 1702 is formed to be relatively sufficiently smaller than a width of one pixel in the X stage travel direction, and relatively sufficiently larger than the detector 112 in the Y stage travel direction. This optical design makes it possible to reduce the influence of the deviation of the imaging relationship between the detector 112 and the image formed on the detector.

It is conceivable that, even in the above first to ninth embodiments, the X stage mainly conducts scanning of a relative long distance, and the position deviation of the transport system is liable to occur. Therefore, the travel direction of the X stage has been described. However, the contents disclosed in the first to ninth embodiments may be applied to the travel direction of the Y stage.

In the first to ninth embodiments, the dark field defect inspection apparatus of the semiconductor wafer has been described. However, the present invention is not limited to this configuration, but can be applied to a bright field defect inspection apparatus, and an inspection apparatus requiring high speed and high precision such as a liquid crystal device or a mask device other than semiconductor.

The contents disclosed in the first to ninth embodiments are preferable particularly in the inspection apparatus using the detector that stores electric charges on the basis of the charge transfer signal.

### REFERENCE SIGNS LIST

101, wafer
102, wafer chuck
103, θ stage
104, Z stage
105, Y stage
106, X stage
107, Y stage linear scale
108, X stage linear scale
109, stage controller
110, measurement unit
111, detection optical system
112, detector
113, sensor control unit
114, image processing unit
115, overall control unit
116, input/output operation unit
117, illumination optical system
118, device mount
119, position deviation information storage unit

1. An inspection apparatus that inspects a substrate, comprising:
a substrate holder that holds the substrate;
a travel unit that travels the substrate holder;
an irradiation unit that irradiates the substrate with light;
a charge storage detector that detects the light from the substrate, and stores electric charges;
a measurement unit that measures a change in relative position between the substrate holder and the travel unit; and
a processing unit,
wherein the charge storage detector stores the electric charges on the basis of a charge transfer signal obtained on the basis of a measurement result from the measurement unit, and
wherein the processing unit detects a defect of the substrate with the use of an image generated by storing the electric charge on the basis of the charge transfer signal.

2. The inspection apparatus according to claim 1,
wherein the measurement unit includes a first measurement unit that measures a change in position of the substrate holder.

3. The inspection apparatus according to claim 2,
wherein the first measurement unit includes a first interference optical system, and
wherein a reference light and an inspection light of the first interference optical system are parallel to a travel direction of the travel unit.

4. The inspection apparatus according to claim 3,
wherein the first interference optical system is arranged through the travel unit and a frame.

5. The inspection apparatus according to claim 3,
wherein the first interference optical system is located at a distance from the travel unit.

6. The inspection apparatus according to claim 1, comprising an imaging unit that images the light from the substrate on the charge storage detector,
wherein the measurement unit includes a second measurement unit that measures a change in position of the imaging unit.

7. The inspection apparatus according to claim 6,
wherein the second measurement unit includes a second interference optical system, and
wherein a reference light and an inspection light of the second interference optical system are parallel to a travel direction of the travel unit.

8. The inspection apparatus according to claim 7,
wherein the second interference optical system is arranged through the travel unit and a frame.

9. The inspection apparatus according to claim 7,
wherein the second interference optical system is located at a distance from the travel unit.

10. The inspection apparatus according to claim 1,
wherein the processing unit changes a brightness of an image in response to a change in the charge transfer signal.

11. The inspection apparatus according to claim 1, comprising:
a pulse source that outputs a pulse for determining a charge transfer signal before correction; and
a high frequency pulse source having a higher frequency than that of the pulse source,
wherein the processing unit corrects the charge transfer signal before correction on the basis of a pulse from the high frequency pulse source, and
wherein the charge transfer signal after correction is output from the high frequency pulse source.

12. An inspection apparatus that inspects a substrate, comprising:
a substrate holder that holds the substrate;
a travel unit that travels the substrate holder;
an irradiation unit that irradiates the substrate with light;
a charge storage detector that detects the light from the substrate, and stores electric charges; and
a processing unit,
wherein the processing unit obtains a position deviation of the substrate from at least two images, and determines a charge transfer signal for allowing the charge storage detector to store the electric charges from the position deviation,
wherein the charge storage detector stores the electric charge on the basis of the charge transfer signal obtained from the position deviation, and
wherein the processing unit detects a defect of the substrate with the use of an image generated by storing the electric charge on the basis of the charge transfer signal.

13. The inspection apparatus according to claim 12,
wherein the processing unit changes brightness of the image in response to a change in the charge transfer signal.
